(19) United States
(12) Patent Application Publication
(10) Pub. No.: US 2008/0008509 A1
(43) Pub. Date: Jan. 10, 2008

(54) Receiving module intended for a document processing line, a stacker intended for a document processing line provided with such a receiving module and a method for stacking document products utilizing such a receiving module

(75) Inventors: Ludovicus Wilhelmus A. Hamers, Westzaan (NL); Bernardus Cornelis Tichelaar, Zaandam (NL)

Correspondence Address: BIRCH STEWART KOLASCH & BIRCH, PO BOX 747, FALLS CHURCH, VA, 22040-0747, US

(73) Assignee: Buhrs-Zaandam B.V., Zaandam (NL)

(21) Appl. No.: 11/822,691

(22) Filed: Jul. 9, 2007

(30) Foreign Application Priority Data
Jul. 7, 2006 (NL) 1032133

(51) Int. Cl. G03G 15/00

(52) U.S. Cl. 399/405

(57) ABSTRACT

A receiving module intended for a document processing line, which comprises a frame and at least one pair of supports which are bringable into a receiving position, wherein one or more document products can rest on the supports, and a releasing position, wherein document products are released by the supports for passage in downward direction, wherein the supports of a pair extend substantially in one plane and are arranged to be movable away from each other and towards each other in that plane for assuming the releasing position and the receiving position, wherein the supports are each provided with a bearing surface on which a lowermost document product rests in use, which bearing surface is designed such that, when the supports move away from each other, substantially no relative sliding movement occurs between the bearing surface and a lower side of the lowermost document product. The invention further relates to a stacker with such a receiving module and to a method for stacking document products.

The invention relates to a receiving module intended for a document processing line, for instance for use in a stacker, where the receiving module comprises a frame and at least one pair of supports which are bringable into a receiving position and a releasing position, where, in the receiving position, one document product or a stack of document products can rest on the supports and where, in the releasing position, one document product or a stack of document products is released by the supports for passage in downward direction.

Such a receiving module is known from practice. With the known receiving module, document products are received on a pair of supports. Document products are understood to mean: documents, magazines, packaged documents, for instance in envelopes, packaged magazines, for instance in film, or other similar products. When a stack of document products is formed on the supports, the supports can slide away from each other so that the stack of products is allowed to pass through the formed opening to a lower surface. However, such receiving modules have the drawback that, when the supports slide open, the lowermost document product can be damaged. Between the document product and the supports, a frictional force occurs when the supports are moved away from each other. The frictional force can tear, crumple or otherwise damage the document product. It is also possible that, due to the occurring frictional force, the one support slides away from under the document product better than the other support. As a result, it is possible for the stack of document products to be allowed to pass through the created opening obliquely and to fall apart or to end up on the lower surface as a deformed stack. The oblique passage may also occur if the supports are designed as supports foldable in downward direction. The supports fold open in downward direction when the document products need to be allowed to pass. These supports pivoting in downward direction require much overall height, which is undesired. If the supports do not fold open exactly the same, so simultaneously and at an equal speed, the document products will fall obliquely through the opening, so that damage or, in the case of a stack of products, falling apart thereof can occur. Particularly if the stack of document products needs to be conveyed further in the document processing line, this is unfavorable.

The invention therefore contemplates providing a receiving module intended for a document processing line, wherein the receiving module receives the document products and forms or does not form them into a stack, wherein the receiving module allows the one document product or a stack of document products to pass evenly in order to prevent the document products from being allowed to pass in an undesired manner, while moving, displacing, tearing, folding, crumpling or other manners of damaging the document products can be maximally prevented. Preferably, the receiving module is also designed to be compact in vertical direction or height.

To this end, the invention provides a receiving module according to the type described in the introduction, characterized in that the supports of a pair extend substantially in one plane and are arranged to be movable away from each other and towards each other in that plane for assuming the releasing position and the receiving position, while the supports are each provided with a bearing surface on which a lowermost document product rests in use, while the bearing surface is designed such that, when the supports move away from each other, substantially no relative sliding movement occurs between the bearing surface and a lower side of the lowermost document product. During use of such a receiving module, no frictional forces arise between the lowermost document product and the bearing surface of the supports located therebelow during the moving away from each other of the supports. This prevents damage and lateral displacement of the document products.

According to a further elaboration of the invention, the bearing surface of each support is formed by a belt stretched over a first return pulley, while an upper part of the belt is fixedly connected with the frame. Because the bearing surface is designed in this manner, the belt is removable from the lower side of a document product by displacing the lower part of the belt and the return pulley to a side of the support facing away from the return pulley, so that the passage opening between the supports becomes larger in an even manner. As a result, the passage opening of the stack will become larger in an even manner and the stack of products can be allowed to pass in an even manner.

In a further elaboration of the invention, the belt is provided so as to be closed upon itself over a supporting frame movably arranged in the above-mentioned plane, which supports the first return pulley and a second return pulley. The endless belt can make a forward movement and a backward movement over the return pulleys by displacing the supporting frame. Because the belt is, on an upper side, fixedly connected with the frame, the belt will move away from under the document products when the supports are moved away from each other, so that the bearing surfaces of the supports move away from each other, as it were, without creating a sliding movement between the bearing surface formed by the belt and the lowermost document product, however.

According to a further elaboration of the invention, the first return pulley is included in the supporting frame in a spring-mounted manner. The spring-mounted inclusion may be realized in that the first return pulley is connected with the supporting frame via a biased compression spring. The return pulley included in a spring-mounted manner in the supporting frame prevents, for instance, fingers, tools or other objects from getting stuck between the supports when they move towards each other again to assume the receiving position. Further, the high-speed mechanism itself is protected from damage. The spring ensures that the respective first return pulleys of both supports can somewhat move away from each other again if it appears that something has got stuck between them.

According to a further elaboration of the invention, the supporting frame is bearing-mounted in guide rails provided on the frame. In an alternative embodiment, ends of the first and second return pulleys are suspended in a guide rail on the frame in a bearing-mounted manner. It is favorable when the guide rails extend parallel to the above-mentioned plane, while they have at least the length of two support lengths and a passage opening length for the document products. In this manner, the supports slide smoothly through the guide rails, so that quick opening and closing of the passage opening is possible and the passage opening is always sufficiently large to allow the document products to pass. Also with high supply rates, of the order of 15,000-20,000 document products per hour, the supports can be moved back and forth sufficiently fast to still guarantee a good processing of the document products.

According to a further elaboration of the invention, each pair of supports has a drive element comprising at least one endless drive belt, wherein an upper part of the drive belt is connected with the one support and a lower part of the drive belt is connected with the other support for displacement of the respective supports. In this manner, the supports are simultaneously displaced over a same distance at a same speed by the at least one endless drive belt.

Further, according to a further elaboration of the invention, each pair of supports may be provided with a drive for driving the at least one drive element, while the drive is arranged for driving the drive element in a forward and in a backward direction of movement. The same drive provides both the opening of the supports and the closing of the supports.

According to an alternative elaboration of the invention, the module has a first pair of supports for a first stacking of document products and at least one next pair of supports for a further stacking of document products, while these pairs of supports are provided substantially at a distance from one another above one another. Due to this arrangement of the module, a first small stack can be formed, which is allowed to pass to the next pair of supports, after which a next stack can be formed on the first pair of supports. In a stepwise manner, the stack is built up and allowed to pass to a lower surface. In this manner, deformation and any falling apart of the stacks of document products due to the large drop height is further prevented.

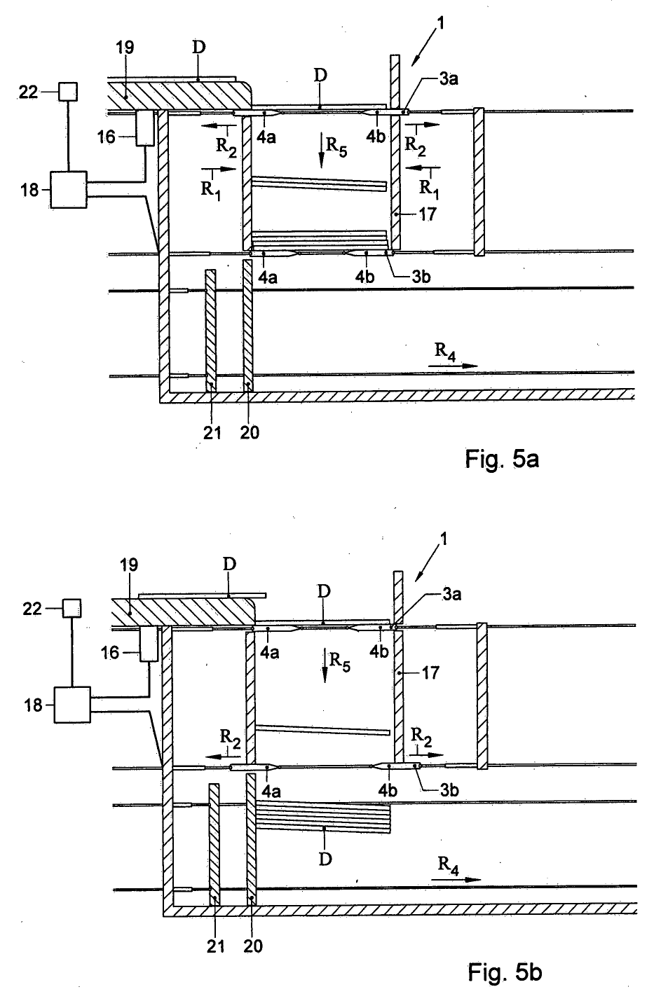

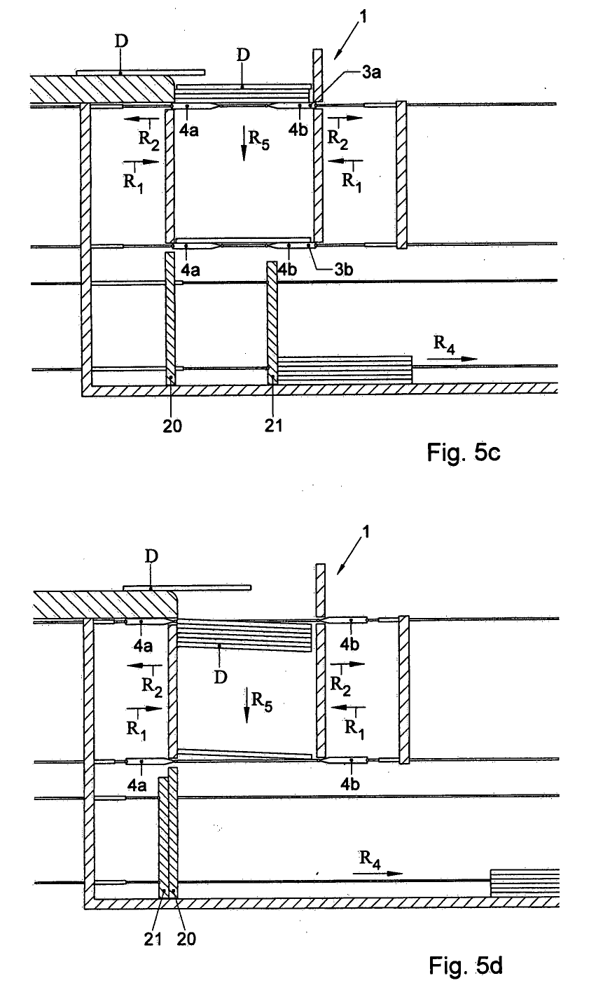

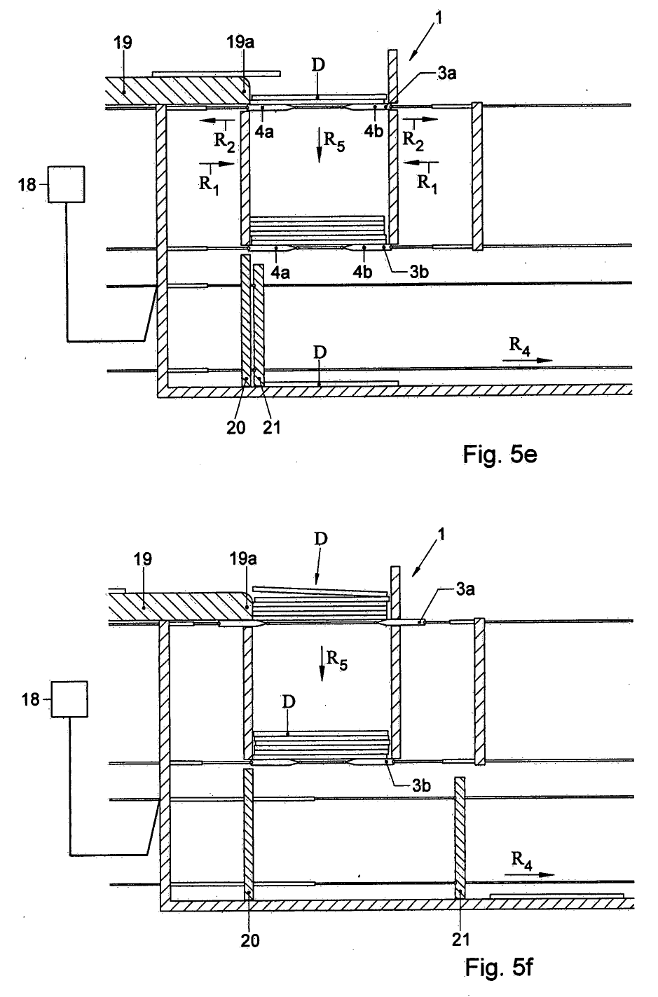

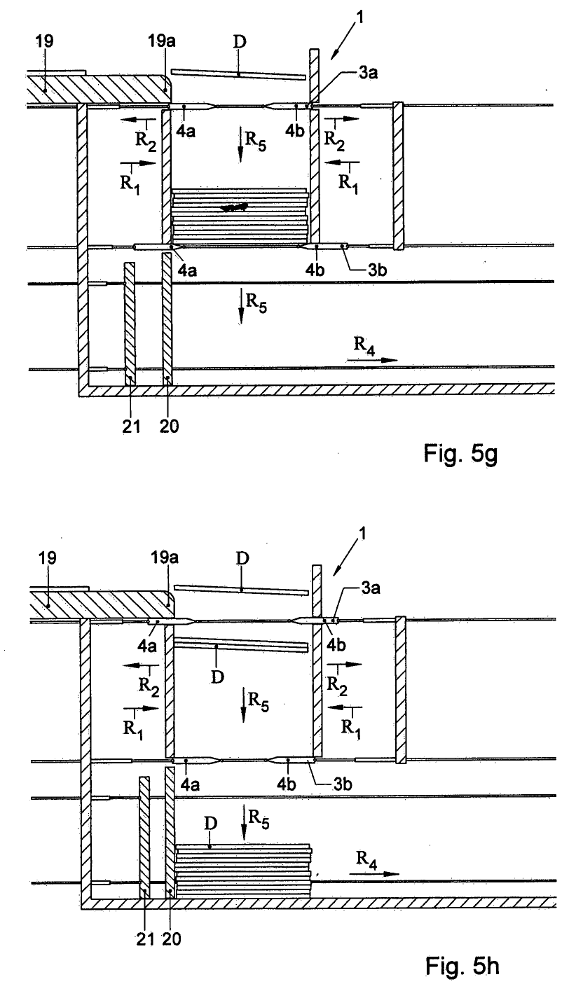

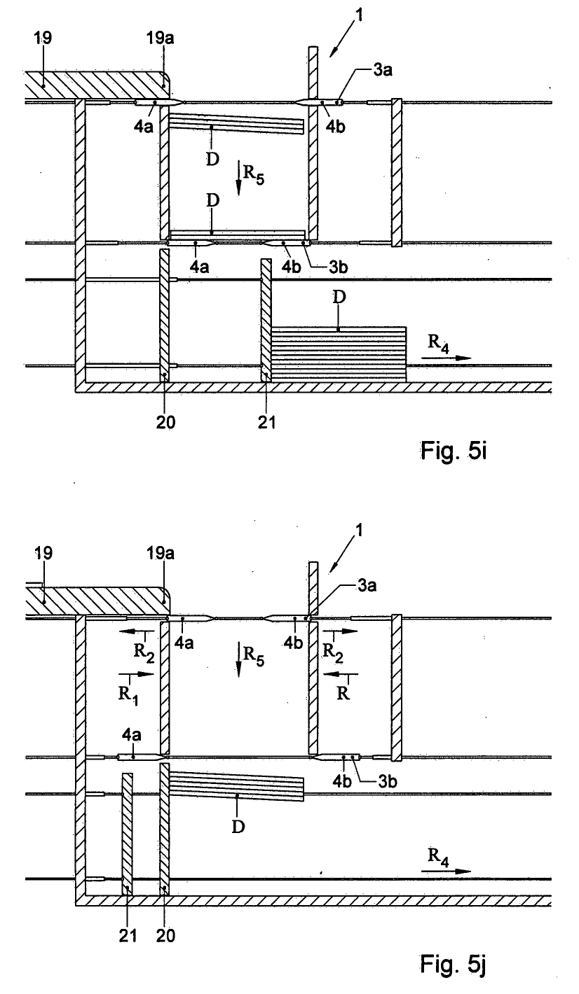

Further, a buffer function can be added when using two pairs of supports which are arranged one above the other. When the receiving module is provided with only one pair of supports, the stack discharge rate determines a minimum stack height. This is because the products supplied to the receiving module during the discharge of a stack allowed to pass by the pair of supports need to be buffered on the single pair of supports until the already formed stack which is discharged below the supports has been discharged. Due to a smart cooperation of two pairs of supports, the supply flow of products can be detained (buffered) somewhat in order to have the stack discharge temporarily discharge a smaller stack than the minimum stack size. Thus, when the occasion arises, the machine speed does not need to be adjusted down temporarily, which provides a higher net output. All this is explained in more detail with reference to FIG. 5.

According to a further elaboration of the invention, the module has a control for controlling the drive of the at least one pair of supports. The control can control the drive of one pair of supports such that the supports are moved away from each other and towards each other at the right time at a right speed. Also, the control can control multiple drives of multiple pairs of supports which are provided one below the other. In addition to the opening and closing of the supports, the control also provides the mutual time difference between the opening and closing of the pairs. As a result, a first pair of supports can be controlled to allow a first stack of document products to pass while a second pair of supports is simultaneously controlled to move the supports towards each other. The control can respond to a sensor which, for instance, counts the number of document products passing, but also to, for instance, the weight of the total stack of document products or dimensions of document products.

According to an alternative embodiment of the invention, the control is programmable for assuming the releasing position and the receiving position of the at least one pair of supports for forming stacks of document products. In this manner, it can be predetermined how large the stacks of document products are to be before the pair of supports allow them to pass, in other words, of how many document products the stacks are to consist. Further, it can be indicated what the dimensions of the products are, in order to displace the supports minimally with respect to one another. This is favorable to the throughput rate of the document processing line. Further, the control can be programmed such that, when the document product is changed, the settings of the receiving module are adjusted thereto. If a sensor is present, it can pass on to the control that a different type of document product is coming, so that the settings can be changed.

The invention further relates to a stacker intended for a document processing line, provided with an above-mentioned receiving module.

The invention further relates to a method where an above-mentioned receiving module is provided in an above-mentioned stacker, while document products are supplied by a supply conveyor to a pair of supports of the receiving module, while, upon opening of the supports, the document products end up on a discharge element located below the first pair of supports, after which the discharge element discharges the stack of document products.

Such a stacker and such a method provide the same advantages as those mentioned with the receiving module.

According to a further elaboration of the method, on a first pair of supports of the receiving module, a first stack of document products can be formed, while, after the document products are allowed to pass by the first pair of supports, they form a next stack of document products on at least one next pair of supports provided at a distance therebelow, before the document products are allowed to pass to the discharge element. Due to this smart control of the first pair of supports and the next pair of supports, a buffer function can be created in the receiving module. The steady supply of products can temporarily be buffered on the first, upper pair of supports, while a small stack on the next, lower pair of supports can be allowed to pass and be discharged. Thus, even the discharge of a stack consisting of only one product is possible while, in the time needed for discharging such a stack, multiple products are supplied.

Further elaborations of the invention are described in the subclaims and will hereinafter be explained in more detail with reference to the drawings, in which:

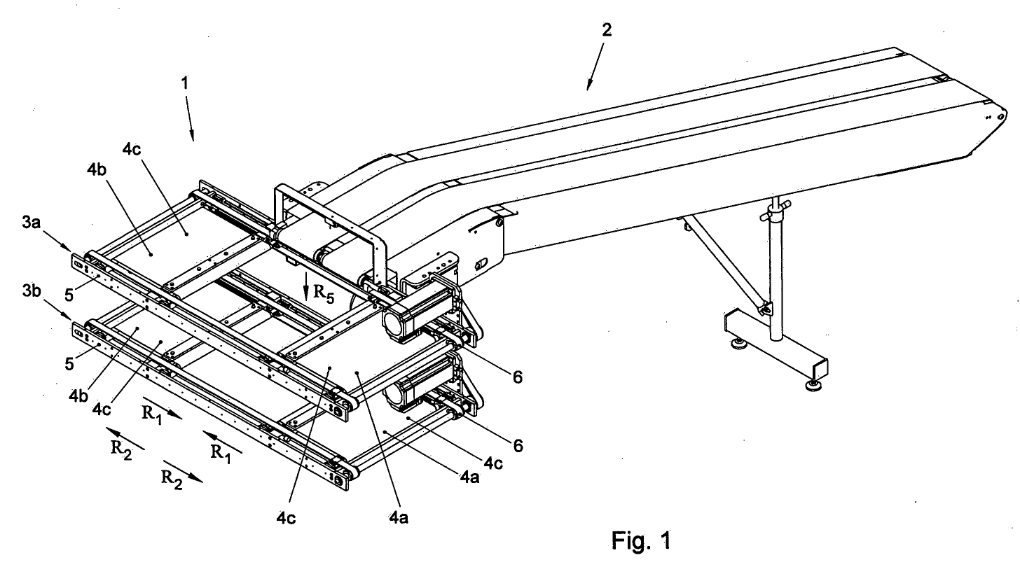

FIG. 1 shows a perspective view of a receiving module;

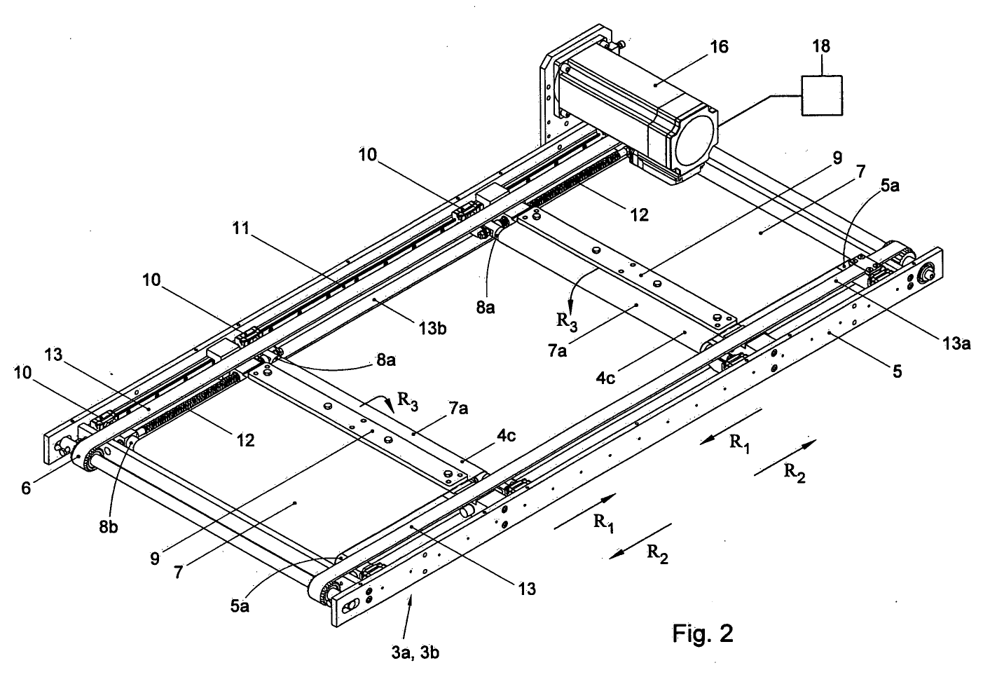

FIG. 2 shows a perspective view of a pair of supports;

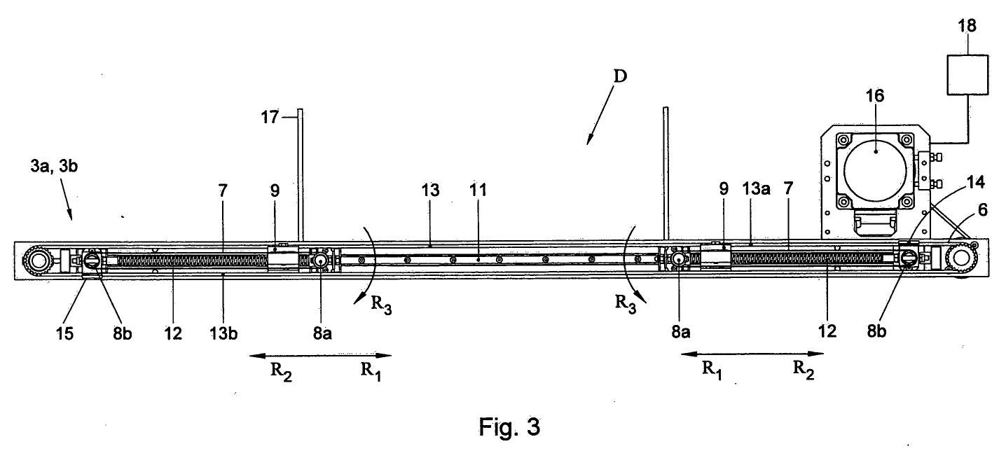

FIG. 3 shows a side elevational view of a pair of supports;

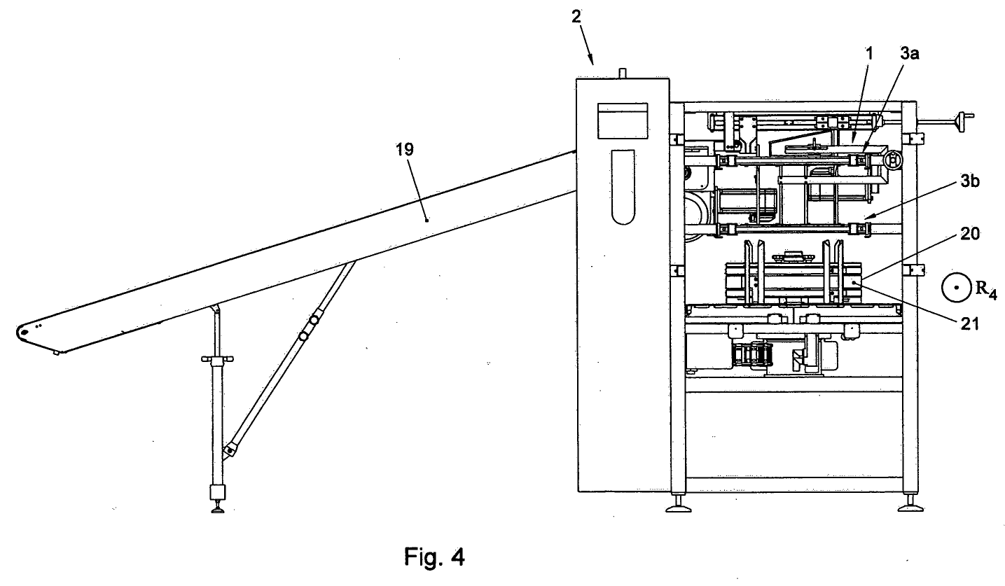

FIG. 4 shows a side elevational view of a stacker;

FIGS. 5a-5j show steps of the method for stacking document products.

In the Figures, same parts are designated by same reference numerals.

FIG. 1 shows a receiving module 1 intended for a document processing line, for instance for in a stacker 2. In this exemplary embodiment, the receiving module 1 comprises two pairs of supports 3a, 3b. Each pair of supports 3a, 3b is bringable into a receiving position and a releasing position. In the receiving position, one document product D or a stack of document products D can rest on the supports 4a, 4b. In the releasing position (as shown in FIG. 1), one document product D or a stack of document products D can be released by the supports 4a, 4b for passage in downward direction R₅. Each pair of supports 3a, 3b is included in a frame 5 in which the supports 4a, 4b of a pair 3a, 3b extend in one plane. The supports 4a, 4b are each provided with a bearing surface 4c on which a lowermost document product D rests in use. The bearing surface 4c is designed such that, when the supports 4a, 4b move away from each other, substantially no relative sliding movement occurs between the bearing surface 4c and a lower side of the lowermost document product D. This prevents lateral transfer of movement.

By means of a drive element 6, the supports 4a, 4b are movable towards each other in direction R₁ and away from each other in direction R₂ in the above-mentioned plane so that either the releasing position or the receiving position can be assumed. Both the moving towards each other and the moving away from each other of the supports 4a, 4b take place in a very short period of time, for instance in 50 ms. The drive element 6 is arranged such that it can move the supports 4a, 4b simultaneously and in opposite direction of movement R₁ or R₂.

FIG. 2 shows a perspective view of a pair of supports 3a, 3b and FIG. 3 shows a side elevational view of the pair of supports 3a, 3b of FIG. 2. The bearing surface 4c of each support 4a, 4b is formed by a belt 7 which is stretched over a first return pulley 8a. The upper part 7a of the belt 7 is fixedly connected with the frame 5, for instance with fastening 9. The belt 7 is provided so as to be closed upon itself over a supporting frame 5a movably arranged in the above-mentioned plane, which supports the first return pulley 8a and the second return pulley 8b.

In another embodiment, the belt may not be closed upon itself. In that variant, the upper part will also be fixedly connected with the fixed frame and a first return pulley will be movably arranged in the above-mentioned plane using a supporting frame. In that variant, the lower part may be connected with a stretching device which keeps the belt stretched when displacing the return pulley. It is even possible for the stretching device to bring about the return pulley displacement as well, for instance when the return pulley is spring-mounted.

The return pulleys 8a, 8b are kept at a distance by at least one spacer 12. These spacers 12 are provided between the return pulleys 8a, 8b near the guide rails 11. The spacers ensure an even displacement of the inner return pulleys 8a with the outer return pulleys 8b. The spacers 12 also provide the sliding back of the inner return pulleys 8a when the drive element 6 displaces the outer return pulleys 8b to their starting position. The first return pulley 8a is included in the supporting frame 5a in a spring-mounted manner. For this, the spacer 12 comprises a spring, which is pressure-biased. The springs ensure that, if an object should end up between the supports 4, it will not get stuck between the supports 4a, 4b. The spring then makes the inner return pulleys 8a move away from each other a bit, so that the object, such as for instance a person's fingers, does not, or at least not severely, become damaged.

The ends 10 of the return pulleys 8a, 8b are displaceably bearing-mounted in a guide rail 11 on the frame 5. In another embodiment, it is also possible that the supporting frame 5a is displaceably bearing-mounted in the guide rail 11 provided on the frame 5. So, when the supports 4a, 4b are moved away from each other in direction R₂ by the drive element 6, the return pulleys 8a, 8b move in direction R₂. Because the belts 7 are fixed on the side facing the document products D with the fastening 9, near the first return pulleys 8a, the belts 7 move away from the lower side of the document product present there in direction R₃.

As can be seen, the guide rails 11 extend parallel to the above-mentioned plane of the supports 4a, 4b. The length of the guide rails 11 is larger than the lengths of the two supports and the length of the passage opening for document products D together. As a result, the pairs of Q supports 3a, 3b are suitable for allowing small document products D, for instance with a length of about 155 mm, up to and including document products D with a size fitting through the maximum passage opening, for instance about 420 mm, to pass. The width adjustment of the supports may take place via servo technique.

The drive element 6 of each pair of supports 3a, 3b comprises two endless drive belts 13. The second return pulley 8b of a first support 4a is connected with an upper part 13a of the drive belt 13 with a fastening 14 and a second return pulley 8b of the second support 4b is connected with a lower part 13b of the drive belt 13 with a fastening 15. This configuration of the drive element 6 brings about a simultaneous displacement of the supports 4a, 4b in an opposite direction R₁ or R₂ at an equal speed.

Each pair of supports 3a, 3b further comprises a drive 16 for driving the drive element 6. The drive 16 can displace the drive element 6 in a forward direction R₁ and a backward direction of movement R₂.

Further, on a pair of supports 3a, 3b, a bottomless box 17 may be placed in which the document products D may be received, as shown in FIG. 3. The receiving module 1 may further be provided with a control 18 (schematically shown) for controlling the drive 16 of a pair of supports 3a, 3b. This control 18 may be programmed for opening and closing the supports 4a, 4b of each pair of supports 3a, 3b. This is further elucidated in FIGS. 5a-5j.

FIG. 4 shows a stacker 2 according to the invention. The stacker 2 comprises a receiving module 1 as described hereinabove provided with two pairs of supports 3a, 3b. The stacker 2 further has a supply conveyor 19 with which document products D can be conveyed to the receiving module 1. Upon reaching the receiving module 1, the document products D are stacked on the upper pair of supports 3a of the module 1. The upper pair of supports 3a is located a short distance below an end 19a of the supply conveyor 19. When the stack has obtained the desired size, the upper pair of supports 3a is opened by sliding the supports 4a, 4b away from each other, so that the bearing surfaces 4c of the supports 4a, 4b move away from each other without causing a sliding movement between a lower side of the document products D and the bearing surface. The stack of document products D falls on a next pair of supports 3b arranged below the first pair of supports 3a, which acts in a same manner as the first pair 3a. The stacker 2 further comprises a discharge element 20 located below the lower pair of supports 3b. The discharge element 20 comprises a slider 21 for discharging and/or sliding away the stack of document products D in direction R₄, to, for instance, a next module in the document processing line.

In another embodiment, it is possible that the receiving module comprises more than two pairs of support 3a, 3b. In FIGS. 5a-5j, the method for stacking document products D using a receiving module 1 is illustrated. In this exemplary embodiment, the receiving module 1 has two pairs of supports 3a, 3b. In FIG. 5a, document products D are supplied to the receiving module 1 using the supply conveyor 19. The document products D are deposited on the upper pair of supports 3a. The upper pair of supports 3a is located a short distance below an end 19a of the supply conveyor 19. Because the distance is short, the document product initially falls down over only that short distance. So, the horizontal movement of the supplied products D is stopped quickly and converted into a vertical movement. This prevents tilting of document is products D as a result of the horizontal speed and too large a drop height. When the control 18 passes on to the drive 16 of this pair 3a that the supports 4a, 4b are to move to a releasing position, the drive 16 will displace the supports 4a, 4b. The document products D fall in direction R₅ to a surface therebelow, in this case a next pair of supports 3b. Here, a stack of document products D can be formed as well, which is, for instance, larger than the stack on the upper pair of supports 3a. The lower pair of supports 3b has a buffer function before the stacks of document products D are discharged by the discharge element 20. The discharge of document products by the discharge element 20 proceeds very slowly compared to the document products being allowed to pass by the supports 3a, 3b, for instance five times more slowly than supplying new document products to the receiving module 1. The second pair of supports 3b has a buffer function for creating large stacks of document products. Further, this pair of supports 3b ensures that stacks of one single product D can also be formed. After all, with a slow discharge element 20 and a single pair of supports 3a or 3b, the smallest stack to be formed will still need to comprise a minimum number of products, for instance about five products.

FIG. 5b shows that the upper pair of supports 3a is in a receiving position and that the lower pair of supports 3b is in a releasing position and has just allowed a stack of document products D to pass. The control 18 can be connected with a sensor 22. The sensor 22 can, for instance, pass on the amount of document products D having passed, weight of the document products D or changes in dimensions of passing document products D to the control 18, after which the control 18 can control the drives 16 of the pairs of supports 3a, 3b on the basis thereof. The control 18 may be programmed on the basis of existing regularly recurring document product flows. On the basis of the information from the sensor 22 and on the basis of the programmed information, the control 18 will send different orders to the drives 16.

FIGS. 5c-5j clearly show that different sizes of stacks can be formed by the configuration of the receiving module 1 with two pairs of supports 3a, 3b and discharge element 20. In FIGS. 5c-5f, a single product D is allowed to pass by the supports 3a, 3b and finally discharged by the discharge element 20 in FIG. 5f. In FIGS. 5e-5i, it can be seen that the lower pair of supports 3b has a buffer function so that a large stack of document products D can be formed, which is discharged by the discharge element 20 in FIG. 5i.

The control 18 can also control the slider 21 of the discharge element 20, as shown in FIGS. 5e and 5f. When the stack of document products D has ended up on the discharge element 20, the control 18 controls the slider 21 to displace the stack of document products D in direction R₄, for instance to a next module in the document processing line. The opening and closing of the different pairs of supports 3a, 3b can be controlled independently of one another, and the opening speed and the intervals between opening and closing may also be controlled independently.

It is clear that the invention is not limited to the exemplary embodiment described but that various modifications are possible within the framework of the invention, as defined by the claims. It is, for instance, possible that the receiving module is provided with multiple pairs of supports which are provided one below the other. This allows multiple stacks to be buffered between times. Further, the stacker according to the invention may comprise multiple receiving modules. Instead of designing the supports with a belt whose upper part is connected with the fixed world, the supports may also comprise a number of freely rotating supporting pulleys included in a displaceable supporting frame. Instead of freely rotating pulleys, the pulleys may be rotated via a gearwheel and a fixed gear rack engaging a side facing upwards of the gear wheel corresponding with a pulley during displacement of the supporting frame. With such an embodiment, a relative sliding movement between support and lowermost product is prevented as well.

1. A receiving module intended for a document processing line, for instance for use in a stacker (2), wherein the receiving module (1) comprises a frame (5) and at least one pair of supports (3a, 3b) which are bringable into a receiving position and a releasing position, wherein, in the receiving position, one document product (D) or a stack of document products (D) can rest on the supports (4a, 4b) and wherein, in the releasing position, one document product (D) or a stack of document products (D) is released by the supports (4a, 4b) for passage in downward direction (R₅), characterized in that the supports (4a, 4b) of a pair (3a, 3b) extend substantially in one plane and are arranged to be movable away from each other and towards each other in that plane for assuming the releasing position and the receiving position, wherein the supports (4a, 4b) are each provided with a bearing surface (4c) on which a lowermost document product (D) rests in use, wherein the bearing surface (4c) is designed such that, when the supports (4a, 4b) move away from each other, substantially no relative sliding movement occurs between the bearing surface (4c) and a lower side of the lowermost document product (D).

2. A receiving module according to claim 1, wherein the bearing surface (4c) of each support (4a, 4b) is formed by a belt (7) which is stretched over a first return pulley (8a), wherein an upper part (7a) of the belt (7) is fixedly connected with the frame (5).

3. A receiving module according to claim 2, wherein the belt (7) is provided so as to be closed upon itself over a supporting frame (5a) movably arranged in the said plane, which supports the first return pulley (8a) and a second return pulley (8b).

4. A receiving module according to claim 2, wherein the first return pulley (8a) is included in the supporting frame (5) in a spring-mounted manner.

5. A receiving module according to at least claim 4, wherein the first return pulley (8a) is connected with the supporting frame (5) via a biased compression spring.

6. A receiving module according to claim 3, wherein the supporting frame (5a) is bearing-mounted in guide rails (11), which are provided on the frame (5).

7. A receiving module according to claim 3, wherein ends (10) of the first and second return pulleys (8a, 8b) are bearing-mounted in guide rails (11), which are provided on the frame (5).

8. A receiving module according to claim 6, wherein the guide rails (11) extend parallel to said plane, wherein they have at least the length of two support lengths and a passage opening length for the document products (D).

9. A receiving module according to claim 1, wherein each pair of supports (3a, 3b) has a drive element (6) comprising at least one endless drive belt (13), wherein an upper part (13a) of the drive belt (13) is connected with one support (4a) and a lower part (13b) of the drive belt (13) is connected with the other support (4b) for the displacement of the respective supports (4a, 4b).

10. A receiving module according to claim 1, wherein each pair of supports (3a, 3b) is provided with a drive (16) for driving the at least one drive element (6), wherein the drive (16) is arranged for driving the drive element (6) in a forward (R₁) and in a backward direction of movement (R₂).

11. A receiving module according to claim 1, wherein the module (1) has a first pair of supports (3a) for a first stacking of document products (D) and at least one next pair of supports (3b) for a further stacking of document products (D), wherein these pairs of supports (3a, 3b) are provided substantially at a distance from one another above one another.

12. A receiving module according to claim 10, wherein the module (1) has a control (18) for controlling the drive (16) of the at least one pair of supports (3a, 3b).

13. A receiving module according to claim 12, wherein the control (18) is programmable for assuming the releasing position and the receiving position of the at least one pair of supports (3a, 3b) for forming stacks of document products (D).

14. A stacker intended for a document processing line, provided with a receiving module (1) according to claim 1.

15. A method of stacking document products, wherein a receiving module (1) according to claim 1 is provided in a stacker (2) according to claim 14, wherein document products (D) are supplied by a supply conveyor (19) to a pair of supports (3a, 3b) of the receiving module (1), wherein, upon opening of the supports, the document products (D) end up on a discharge element (20) located below the first pair of supports (3a, 3b), after which the discharge element (20) discharges the document products (D).

16. A method according to claim 15, wherein the pair of supports (3a, 3b) is provided a short distance below an end (19a) of the supply conveyor (19).

17. A method according to claim 15, wherein, on a first pair of supports (3a) of the receiving module (1), a first stack of document products (D) is formed, wherein, after the first pair of supports (3a) allow the document products (D) to pass, they form a next stack of document products (D) on at least one next pair of supports (3b) provided at a distance therebelow, before the document products (D) are allowed to pass the discharge element (20).

18. A receiving module according to claim 3, wherein the first return pulley (8a) is included in the supporting frame (5) in a spring-mounted manner.

19. A receiving module according to claim 4, wherein the supporting frame (5a) is bearing-mounted in guide rails (11). which are provided on the frame (5).

20. A receiving module according to claim 5, wherein the supporting frame (5a) is bearing-mounted in guide rails (11), which are provided on the frame (5).
